(19) United States
(12) Patent Application Publication
(10) Pub. No.: US 2018/0188967 A1
(43) Pub. Date: Jul. 5, 2018

(54) SNAPSHOT STORAGE MANAGEMENT

(71) Applicant: HEWLETT PACKARD ENTERPRISE DEVELOPMENT LP, Houston, TX (US)

(72) Inventors: Girish Chandra Belmanu Sadananda, Bangalore (IN); Santosh Balaraj Bangalore, Bangalore (IN); Alastair Slater, Bristol (GB)

(21) Appl. No.: 15/737,592

(22) PCT Filed: Sep. 23, 2015
(86) PCT No.: PCT/US2015/051596

§ 371 Date: Dec. 18, 2017

(30) Foreign Application Priority Data
Jul. 31, 2015 (IN) 3949/CHE/2015

(51) Int. Cl. G06F 3/06

(52) U.S. Cl. CPC G06F 3/065; G06F 3/0644; G06F 3/0673; G06F 3/0604

(57) ABSTRACT

In one example, primary data storage volume to store primary data blocks, and snapshot data storage volume to store snapshot data with snapshot data blocks representing copy-on-write (COW) data blocks of the primary data blocks, and with snapshot pointers to reference the primary data blocks representing non-COW data blocks of the primary data blocks of the primary data storage volume. A mapping table with primary volume mapping pointers to reference the primary data blocks, and snapshot volume mapping pointers to reference the snapshot data blocks. In response to a restore operation, perform a swap function that includes: updating the mapping table to have the primary volume mapping pointers to reference corresponding COW data blocks of the snapshot data storage volume, updating the mapping table to have the snapshot volume mapping pointers to reference corresponding primary data blocks of the primary data storage volume.

### BACKGROUND

Computer systems include computing devices with storage devices for storing data for later retrieval. The computing devices may include functionality to provide backup and restore techniques in case of data corruption of data on the storage devices.

### BRIEF DESCRIPTION OF THE DRAWINGS

Examples are described in the following detailed description and in reference to the drawings, in which:

FIG. 1 depicts an example system for snapshot storage management in accordance with an example of the techniques of the present application;

FIG. 2 depicts an example flow chart of a process for snapshot storage management in accordance with an example of the techniques of the present application:

FIGS. 3A through 3C depict example diagrams of snapshot storage management in accordance with an example of the techniques of the present application; and

FIG. 4 depicts an example block diagram showing a non-transitory, computer-readable medium that stores instructions for snapshot storage management in accordance with an example of the techniques of the present application.

### DETAILED DESCRIPTION

Computer systems may include a computing device with a storage device for storing data for later retrieval. The computing device may include functionality to provide backup and restore techniques for data recovery or restoration in case of data corruption of data on the storage devices.

The computing device may including functionality to process input/output (IO) commands received from another computing device such as a host computing device. The IO commands may include write commands that include data blocks along with address information which the computing device uses to write the data blocks to the corresponding address locations on a primary data storage volume on a storage device managed by the computing device. The IO commands may include read commands with address information received from the host computing device which the computing device uses to read data blocks located at the corresponding address from the primary data storage volume on the storage device.

The computing device may include functionality to provide backup and restore techniques in case of data corruption of data on the storage device. In one example, data corruption may be defined as conditions or events which may cause the data on the storage device to be negatively impacted. Such conditions may include inability of the computing device to read or retrieve the data from the storage device, the value of the data no longer representing the correct or expected value or not being valid, and the like. The computing device may include a storage device with primary space with primary volumes to store data blocks for and later retrieval by another computing device such as a host computing device. The computing device may include functionality to take snapshots of the primary volumes which involve making a point in time copy of the existing state of the primary volume including the data blocks associated with the primary volume. The computing device may provide a snapshot space includes the snapshot data which may require a relatively small amount of space since it involves a data structure such as a file which includes a list of memory locations which contain the actual data blocks. In one example, a snapshot may include a list of references or pointers which reference or point to the primary volume which contains the actual data blocks. Since the snapshot space contains pointers and not the actual data blocks, the size of a snapshot space may be relatively small compared to the size of the primary volume. The snapshot space may include data blocks which are copy-on-write (COW) data blocks of the data blocks associated with the primary volume. In one example, COW data blocks may be defined as data blocks of the primary volume before the data blocks are overwritten on the primary volume.

In one example, the computing device may include a storage array which includes a storage controller coupled to an array of storage devices with primary data blocks of a primary volume which appear as virtual storage to a host computing device. The computing device may include metadata of the primary volume which may include metadata of a logical unit number (LUN) of regions of the primary volume. In some examples, the metadata of a LUN may include information about the primary volume such as which data blocks of the storage device are used to create the LUN, redundant array of independent drives (RAID) levels and the like. In some examples, the metadata may include mapping information in the form of mapping tables which may provide mapping or a translation of virtual LUN information to physical address information of data blocks of storage at the storage array level.

The computing device may be configured to manage data corruption conditions such as LUN corruptions on the primary volumes. The computing device may take a snapshot of the primary volume to allow a later restore or recovery operation to bring back the primary volume to a state that volume was when the snapshot was taken. The computing device may achieve this restore operation by writing back the data blocks acquired by the snapshot from changes in the data blocks after the snapshot has been taken (i.e., COW data blocks) as well as writing the data blocks that were not changed to the primary volume. This restore operation or process may require the primary volume to be offline and may require a relatively large number writes on the primary volume which may involve a relatively large amount of time which is undesirable. These techniques may require that the computing device rewrite data blocks back on to the primary volume from the snapshot space in case of COW data blocks as well as regions which reference or point to non-zero data on the primary volume.

The present application discloses techniques to provide snapshot management which may improve the data restore process in case of data corruption conditions. For example, instead of rewriting the complete data blocks from the snapshot space back to the primary space, the techniques of the present application include a swap function that swaps blocks using metadata or region mappings (e.g., mapping table) between snapshot space and primary space (Primary volume LUN) during a restore operation. In this manner, changed data blocks in the primary space are added to the snapshot space and data blocks from the snapshot space are added to the primary space which may decrease the amount of time to restore data and recover from data corruptions events or conditions.

For example, the snapshot storage management techniques provide snapshot space that reference primary space to be used during a data restore process operation. In one example, the techniques of the present application may not require writes to the primary volume during a restore so that the amount of time to perform the restore operation may be reduced or minimized. The restore operation may be an offline operation, if the amount of the time the restore process takes can be reduced, then the restore of the primary volume may be performed online which may reduce the amount of time the storage system of the computing device is down or not accessible. In other words, in some examples, these techniques may reduce the number or amount of unnecessary writes on the primary volume (which may be a production volume) during the restore operation, where the snapshot is to be used to restore to the primary volume.

In one example of the present techniques, disclosed is a storage management module configured to provide a primary space that includes primary data storage volume to store primary data blocks. The management module provides a snapshot space to include a snapshot data storage volume to store snapshot data that includes snapshot data blocks which represent COW data blocks of primary data blocks. The module provides the snapshot data storage volume to include snapshot pointers to reference primary data blocks which represent non-COW data blocks of primary data blocks of the primary data storage volume. The module provides a mapping table to include primary volume mapping pointers to reference primary data blocks, and provides snapshot volume mapping pointers to reference snapshot data blocks.

The storage management module is configured to check for a restore command associated with a restore operation. If the storage management module determines the presence or receipt of a restore command, then the module performs a swap function that includes updating the mapping table to have the primary volume mapping pointers to reference corresponding COW data blocks of the snapshot data storage volume. The swap function includes updating the mapping table to have the snapshot volume mapping pointers to reference corresponding primary data blocks of the primary data storage volume.

In this manner, the present application discloses techniques to provide snapshot storage management techniques which may help improve data restore process from snapshot data storage volumes in case of data corruption of primary data storage volumes. For example, the snapshot storage management techniques provide snapshot space that reference primary storage volumes to be used during a data restore process. In another example, these techniques may help improve restore process to restore or recover data to a primary data storage volume from snapshot space with zero writes on the primary volume. This may include a swap function that includes copying COW data blocks using mapping table (e.g. metadata of the primary and snapshot space or region mappings) between snapshot space and primary space during a restore operation such that changed blocks in the primary space are replaced in to snapshot space and snapshot space blocks are replaced in to primary space which may improve the speed of the restore process.

That is, in one example, the present application discloses techniques which implement pointer or reference management functionality in contrast to current techniques which employ rewrite operations of data blocks where necessary. The present techniques may provide other storage restore and recovery improvements. For example, the present techniques may not need to write data blocks associated with mapping (regions) which may reduce the number of primary space data block write operations. In other example, the present techniques may employ zero write operations on primary space which may help reduce the amount of time for the system to come online after the restore. In yet another example, the present techniques may improve restore operation performance which may include executing offline operations that may reduce the amount of time for primary data storage volume to be online thereby improve system availability.

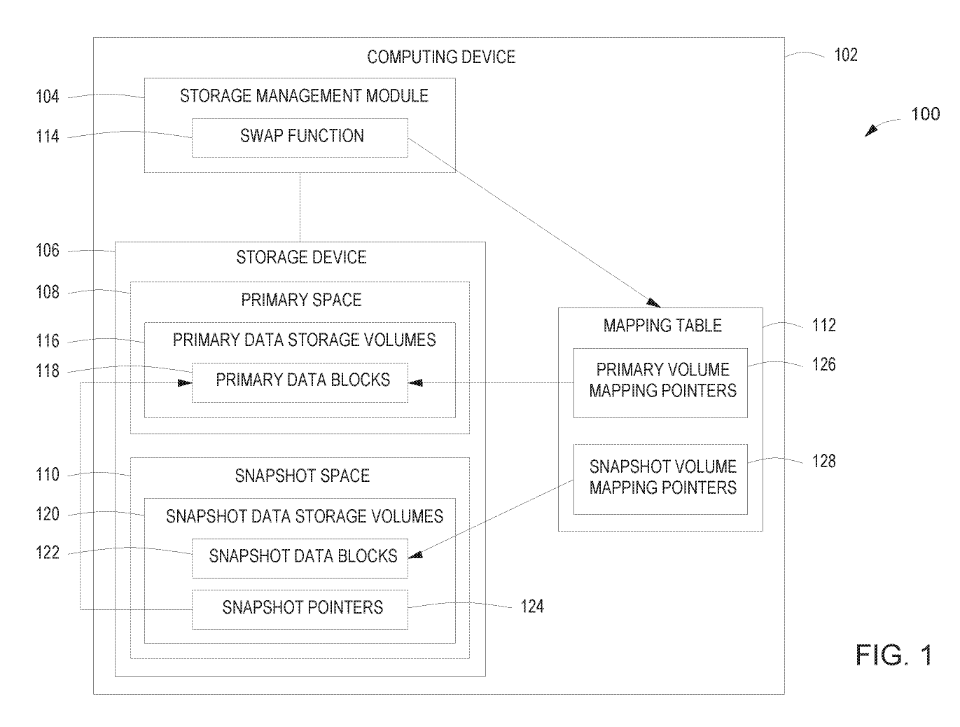

FIG. 1 depicts an example system 100 for snapshot storage management in accordance with an example of the techniques of the present application. The system 100 includes a computing device 102 configured to provide snapshot storage management in accordance with an example of the techniques of the present application.

The computing device 102 includes a storage management module 104 and a storage device 106 with a primary space 108 and a snapshot space 110. The module 104 includes a swap function 114 with a mapping table 112 to manage primary space 108 and snapshot space 110 for snapshot management, as explained below in further detail.

The storage management module 104 is configured to provide primary space 108 that includes primary data storage volumes 116 to store primary data blocks 118. The module 104 provides snapshot space 110 to include snapshot data storage volumes 120 to store snapshot data that includes snapshot data blocks 122 which represent COW data blocks of primary data blocks 118. The module 104 is configured to provide snapshot data storage volume 120 to include snapshot pointers 124 to reference primary data blocks 118 which represent non-COW data blocks of primary data blocks 118 of primary data storage volume 116. The module 104 is configured to provide mapping table 112 to include primary volume mapping pointers 126 to reference primary data blocks 118, and provide snapshot volume mapping pointers 128 to reference snapshot data blocks 122.

The storage management module 104 may be configured to receive and process IO commands from another computing device such as a host computing device. For example, module 104 may be configured to respond to write commands to cause the module to perform write operations that include to write data blocks from the host computing device to primary data storage volume 116. In another example, module 104 may be configured to respond to read commands to cause the module to perform read operations that include to read data blocks from primary data storage volume 116 and return the read data blocks back to the host computing device. In another example, module 104 may be configured to respond to snapshot commands from host computing device to cause the module to perform snapshot operations that include taking point in time copies of the primary data blocks of primary data storage volume 116.

The storage management module 104 is configured to check for a restore operation. If module 104 determines a receipt or presence of a restore operation corresponding to a restore command from the host computing device, then the module performs swap function 114 that includes updating mapping table 112 to have primary volume mapping pointers 126 to reference corresponding COW data blocks 122 of snapshot data storage volume. The swap function 114 includes updating mapping table 112 to have snapshot volume mapping pointers 128 to reference corresponding primary data blocks 118 of the primary data storage volume.

In one example, storage management module 104 may be configured, in response write commands corresponding to write operations and before snapshot operations, to write data blocks to primary data storage volume 116 and not write the primary data blocks to snapshot data storage volume 120. The module 104 may be configured, in response write operations and after snapshot operations, to copy the primary data blocks from primary data storage volume 116 to snapshot data volume 120 and then overwrite the primary data blocks of the primary data storage volume. The module 104 may be configured, in response to snapshot operations, to cause or have snapshot pointers 124 to reference primary data blocks 118 which represent non-COW data blocks of the primary data blocks of primary data storage volume 116. In one example, COW data blocks may represent primary data blocks 118 from primary data storage volume 116 at the time of a snapshot operation before the primary data blocks were subsequently overwritten at the primary data storage volume. In another example, non-COW data blocks represent primary data blocks 118 from primary data storage volume 116 at the time of a snapshot operation that have not been overwritten at the primary data storage volume. In one example, snapshot pointers 124 may be configured to provide snapshots with associations with other snapshots in a hierarchical order. For example, COW data blocks may be associated with the latest snapshot. In that case, the snapshots that were created before the latest snapshot if any pointer in those snapshots were pointing to the changed block, all those snapshots start pointing to that COW data block on the latest snapshot.

The storage device 106 may be defined as any electronic means to store data for later retrieval. The storage device 106 store primary data blocks as primary data storage volumes which may by logical units of data that can be defined across multiple storage devices. The IO requests may include requests to read data from storage device 106 as volumes and requests to write data to the storage devices as volumes. The storage device 106 may refer to a physical storage element, such as a disk-based storage element (e.g., hard disk drive, optical disk drive, etc.) or other type of storage element (e.g., semiconductor storage element). In one example, multiple storage devices within a storage subsystem can be arranged as an array configuration.

The computing device 102 may be configured to communicate with other computing devices such as host computing devices over a network using network techniques. The network techniques may include any means of electronic or data communication. The network may include a local area network, Internet and the like. The network techniques may include Fibre Channel network, SCSI (Small Computer System Interface) link, Serial Attached SCSI (SAS) link and the like. The network techniques may include expanders, concentrators, routers, and other communications devices.

The system 100 of FIG. 1 shows example computing device 102 and should be understood that other configurations may be employed to practice the techniques of the present application. For example, system 100 may be configured to include a plurality of computing devices 102 to communicate with a plurality of other computing devices. In another example, storage device 106 is shown as a single component but it should be understood that the storage device may be plurality of storage devices distributed across a plurality of computing devices 102. In another example, storage management module 104 is shown as a single component but it should be understood that the module may be plurality of modules distributed across a plurality of computing devices 102. The components of system 100 may be implemented in hardware, software or a combination thereof. In one example, module 104 may be implemented in hardware, software or a combination thereof. In another example, the functionality of the components of system 100 may be implemented using technology related to Personal Computers (PCs), server computers, tablet computers, mobile computers and the like.

FIG. 1 shows a system 100 to provide snapshot storage management. The storage system 100 may include computer-readable storage medium comprising (e.g., encoded with) instructions executable by a processor to implement functionalities described herein in relation to FIG. 1. In some examples, the functionalities described herein in relation to instructions to implement storage management module 104 functions, and any additional instructions described herein in relation to storage medium, may be implemented as engines or modules comprising any combination of hardware and programming to implement the functionalities of the modules or engines, as described below. The functions of module 104 may be implemented by a computing device which may be a server, blade enclosure, desktop computer, laptop (or notebook) computer, workstation, tablet computer, mobile phone, smart device, or any other processing device or equipment including a processing resource. In examples described herein, a processor may include, for example, one processor or multiple processors included in a single computing device or distributed across multiple computing devices.

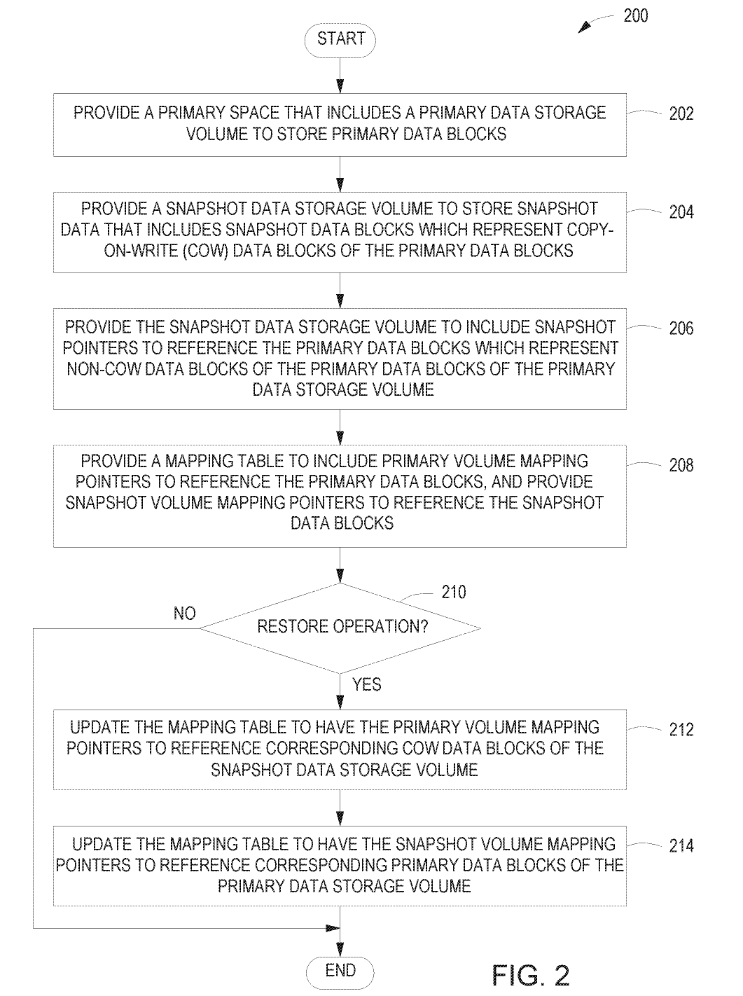

FIG. 2 depicts an example flow chart 200 of a process for snapshot storage management in accordance with an example of the techniques of the present application. To illustrate operation, it may be assumed that process 220 employs system 100 which includes computing device 102 configured to provide snapshot storage management according to the techniques of the present application and functionality described herein.

It should be understood the process depicted in FIG. 2 represents generalized illustrations, and that other processes may be added or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, Application Specific Integrated Circuits (ASICs), or other hardware components associated with the system. Furthermore, the flow charts are not intended to limit the implementation of the present application, but rather the flow charts illustrate functional information to design/fabricate circuits, generate software, or use a combination of hardware and software to perform the illustrated processes.

The process 200 may begin at block 202, where storage management module 104 provides primary space 108 that includes primary data storage volume 116 to store primary data blocks 118. Processing proceeds to block 204.

At block 204, storage management module 104 provides snapshot space 110 to include snapshot data storage volume 120 to store snapshot data that includes snapshot data blocks 122 which represent COW data blocks of primary data blocks 118. Processing proceeds to block 206.

At block 206, storage management module 104 provides snapshot data storage volume 120 to include snapshot pointers 124 to reference primary data blocks 118 which represent non-COW data blocks of primary data blocks 118 of primary data storage volume 116. Processing proceeds to block 208.

At block 208, storage management module 104 provides mapping table 112 to include primary volume mapping pointers 126 to reference primary data blocks 118, and provide snapshot volume mapping pointers 128 to reference snapshot data blocks 122. Processing proceeds to block 210.

At block 210, storage management module 104 checks for a restore operation. If storage management module 104 determines the presence of a restore operation, then processing proceeds to block 212. On the other hand, if storage management module 104 determines no presence of a restore operation, then processing proceeds to End block for other processing.

At block 212, storage management module 104 performs swap function 114 that includes updating mapping table 112 to have primary volume mapping pointers 126 to reference corresponding COW data blocks 122 of snapshot data storage volume. Processing proceeds to block 214.

At block 214, storage management module 104 performs swap function 114 that includes updating mapping table 112 to have snapshot volume mapping pointers 128 to reference corresponding primary data blocks 118 of the primary data storage volume. Processing proceeds to the End block for other processing.

In this manner, the present application discloses techniques to provide snapshot storage management techniques which may help improve data restore process from snapshot data storage volumes in case of data corruption of primary data storage volumes. For example, the snapshot storage management techniques provide snapshot volumes to provide snapshots that reference primary storage volumes to be used during a data restore process.

The process 200 of FIG. 2 shows an example process and it should be understood that other configurations can be employed to practice the techniques of the present application. For example, process 200 may be configured to process primary space 108 and snapshot space 110 that reside on different storage devices 106.

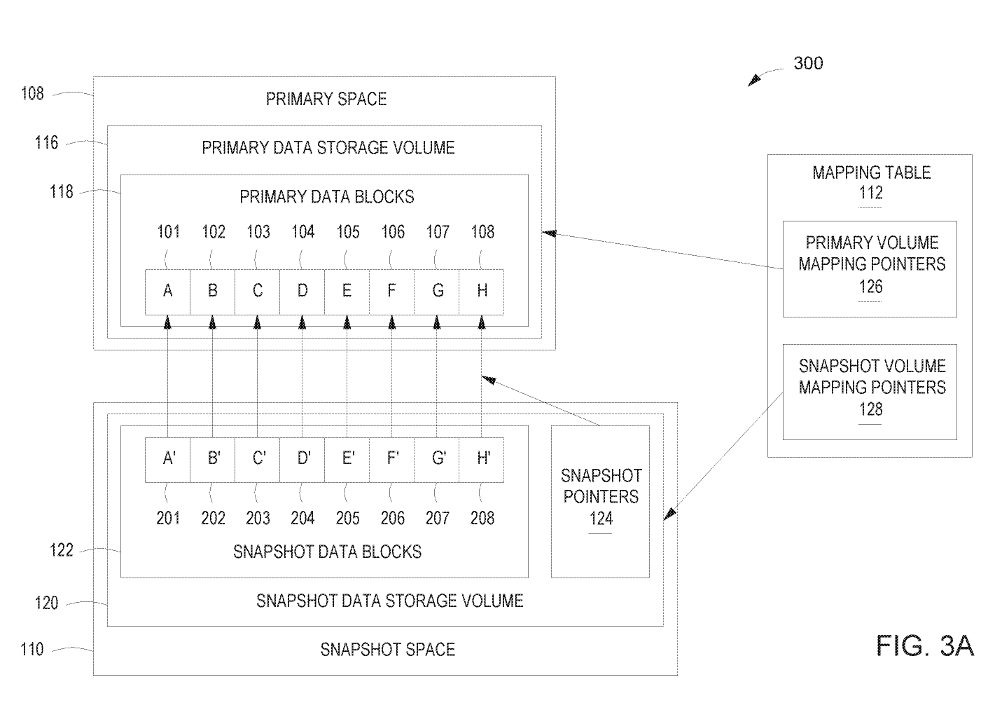

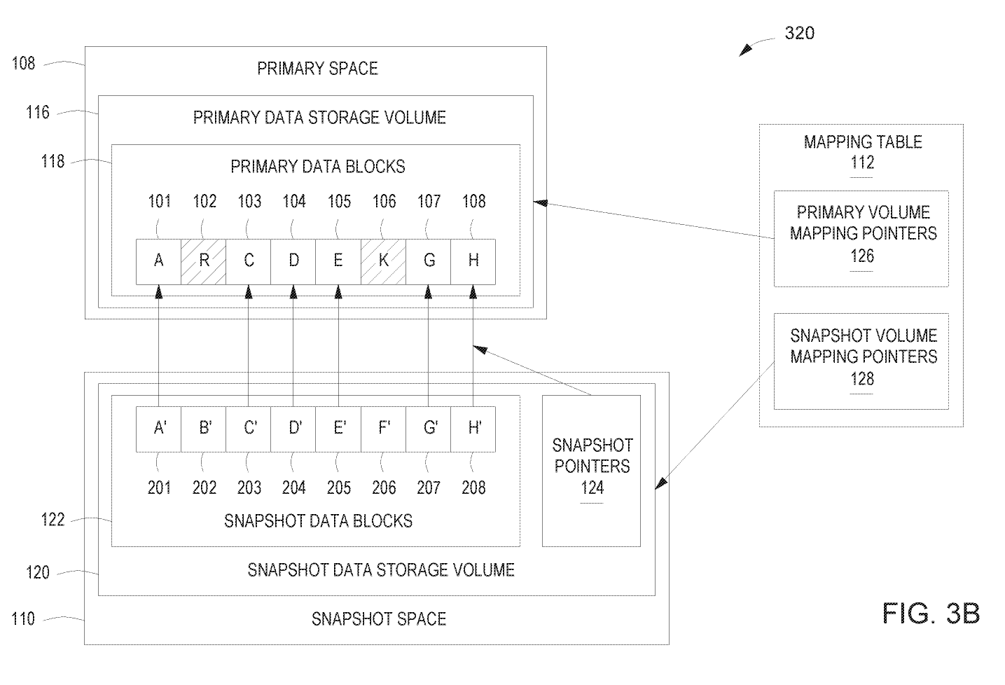

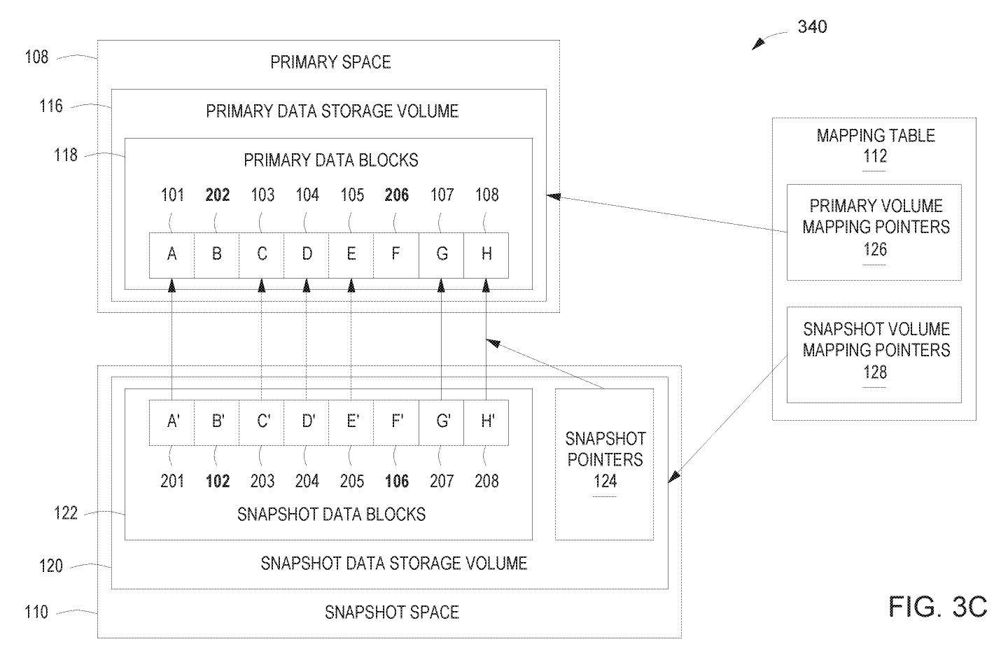

FIGS. 3A through 3C depicts example diagrams of processes for snapshot storage management in accordance with an example of the techniques of the present application. To illustrate operation, it may be assumed that processes of FIGS. 3A through 3C employ system 100 which include computing device 102 configured to provide snapshot storage management techniques in accordance with an example of the techniques of the present application and functionality described herein.

Turning to FIG. 3A, shows an example system 300 illustrating operation that includes computing device 102 that provides snapshot storage management such that snapshot data storage volumes 120 have snapshot pointers 124 but do not have snapshot data blocks 122 that are COW data blocks. In this case, as part of an initial or initialization process, storage management module 104 provides primary space 108 that includes primary data storage volume 116 to store primary data blocks 118. The management module 104 provides snapshot space 110 to include snapshot data storage volume 120 to store snapshot data that includes snapshot data blocks 122 which represent COW data blocks of primary data blocks 118. The module 104 provides snapshot data storage volume 120 to include snapshot pointers 124 to reference primary data blocks 118 which represent non-COW data blocks of primary data blocks 118 of primary data storage volume 116. The module 104 provides mapping table 112 to include primary volume mapping pointers 126 to reference primary data blocks 118, and provides snapshot volume mapping pointers 128 to reference snapshot data blocks 122.

Continuing with this example, to illustrate operation, storage management module 104 receives write commands from another computing device such as a host computing device. The module 104 responds to the write commands by performing write operations that include writing data blocks from the host computing device to primary data blocks 118 (represented by data block values labeled A through H) of primary data storage volume 116. In this case, module 104 then updates mapping table 112 to have primary volume mapping pointers 126 (represented by reference values of 101 through 108) to reference corresponding primary data blocks 118 of primary data storage volume 116.

Continuing with this example, to illustrate operation, storage management module 104 may be configured to respond to read commands to cause the module to perform read operations that include to read primary data blocks 118 from primary data storage volume 116 and return the read data blocks back to the host computing device In this case, module 104 responds to the read commands to cause the module to perform read operations using primary volume mapping pointers 126 (represented by reference values of 101 through 108) to reference and retrieve corresponding primary data blocks 118 (represented by data block values of A through H) of primary data storage volume 116.

Continuing with this example, to illustrate operation, storage management module 104 may be configured to respond to a snapshot command from host computing device to cause the module to perform a snapshot operation that includes executing a point in time copy process that includes generating a copy of the primary data blocks of primary data storage volume 116. In this case, in one example, module 104 continues with the snapshot operation by performing updates of snapshot pointers 124 to reference corresponding primary data blocks 118. In this case, module 104 sets or updates snapshot mapping pointers 128 (represented by reference values of 201 through 208) to reference snapshot data blocks 122 as pointers (represented by values A′ through H′), as shown in diagram 300.

Further continuing with this example, to illustrate operation, storage management module 104 may be configured to respond to a restore command from a host computing device. In one example, the restore command may cause module 104 to perform a restore operation that include performing a restore or data restore process as a result of a data corruption condition. In this case, in one example, storage management module 104 performs the restore operation which includes checking snapshot pointers 124 to determine whether pointers reference corresponding primary data blocks 118. If so, then module 104 determines that there are no data block changes from the time the snapshot was taken to the time the restore command was submitted. In this case, module 104 does not further process the restore command from the host computing device.

Turning to FIG. 3B, continuing with the example described in the context of FIG. 3A, this shows an example system 320 illustrating operation that includes computing device 102 generating a single snapshot that includes a plurality of snapshot data blocks that are COW data blocks. Further continuing with this example, to illustrate operation, storage management module 104 receives write commands from another computing device such as a host computing device. The module 104 responds to the write commands by performing write operations that include writing data blocks from the host computing device to primary data blocks 118 (represented by primary data block values labeled R and K) of primary data storage volume 116. In this case, module 104 determines that primary data blocks B and F correspond to respective data blocks R and K associated with the write command. In this case, module 104 first makes a copy of primary data blocks B and F of primary data storage volume 116 to corresponding snapshot data blocks at snapshot data storage volume 120. Then, once module 104 makes copies, it overwrites the data blocks of primary data storage volume. Then, since primary data blocks are now COW data blocks, module 104 updates mapping table 112 to no longer have primary volume mapping pointers 126 (represented by reference values of 101 through 108) reference corresponding primary data blocks 118 of primary data volume 116, as shown in FIG. 3B.

Turning to FIG. 3C, continuing with the example described in the context of FIG. 3A and FIG. 3B, this shows an example system 340 illustrating operation that includes computing device 102 responding to a restore command. In one example, to illustrate operation, storage management module 104 responds a restore command from a host computing device. In one example, the restore command may cause module 104 to perform a restore operation that include performing a restore or data restore process as a result of a data corruption condition. In this case, in one example, module 104 performs the restore operation which includes checking snapshot pointers 124 to determine whether pointers reference corresponding primary data blocks 118. In this case, module 104 determines that there are data block changes from the time the snapshot was taken to the time the restore command was submitted. In this case, module 104 determines that some snapshot pointers 124 no longer point or reference corresponding primary data blocks 118.

In this case, in one example, storage management module 104 performs a swap function. For example, module 104 performs a swap function that includes updating mapping table 112 to have primary volume mapping pointers 126 to reference corresponding COW data blocks of snapshot data storage volume 120. The swap function further includes updating mapping table 112 to have snapshot volume mapping pointers 128 to reference corresponding primary data blocks 118 of primary data storage volume 116.

In summary, the above example illustrates for example, computing device 102 managing a single snapshot. The snapshot management module 104 manages updates to primary data blocks which generates snapshot data blocks as COW data blocks. In other words, this indicates that primary data blocks of primary data storage volume 116 have changed since a snapshot was taken. In this case, module 104 performs a restore process that includes checking whether any snapshot pointers 124 directly to primary data blocks. If so, then this condition indicates that those blocks are unchanged and therefore there is no need for module 104 to write any data. Then, module 104 checks whether mapping table 112 indicates that mappings are based on COW data blocks. In this case, module 104 does not write back the data blocks from COW data blocks, but rather updates mapping table 112 (remaps) the primary data storage volume 116 to include the data blocks of COW data blocks. In addition, module 104 assigns back respective changed data blocks from primary data storage volume 116 to snapshot space 110. That is, module 104 performs the swap function 114 that involves mapping table 112 (e.g. which may represents metadata of primary and snapshot space regions). Then, module 104 updates mapping table 112 to indicate newly changed data blocks back in snapshot space 110 to reference primary space 108. In this case, since there are no other snapshots that exist, module 104 does not perform further operations based on the swap function and changes to mapping table 112.

In this example, computing device 102 was described in the context of managing a single snapshot. It should be understood that computing device 102 may be configured or capable of managing a plurality of snapshots. For example, storage management module 104 may generate a plurality (multiple) snapshots which are associated with primary space 108 and with primary data blocks as COW data blocks as subsets of the snapshots. In this case, module 104 determines that snapshot space 110 references primary space 108 directly which means the associated data blocks are unchanged, so there is no need to write any data. Then, since existing mapping table 112 mappings are based on COW data blocks, module 104 does not write back the data blocks from the COW data blocks. Rather, module 104 updates mapping table 112 (remaps) the primary space to include the COW data blocks and assigns respective changed data blocks of primary space 108 back to snapshot space 110. That is, module 104 performs swap function 114 using mapping table 112. Then, module 104 adds the new changed data blocks back to snapshot space 110 which reference primary space 108. In this case, all the other existing snapshots trigger COW data blocks of all of the snapshot data storage volumes 120 as if new write operations have been performed on primary data storage volumes 116. As a result, this may cause module 104 to de-reference the swapped regions (primary space and primary space) from all the snapshot data storage volumes which may help to maintain the integrity of the snapshot data.

In this manner, the present application discloses techniques to provide snapshot storage management techniques which may help improve data restore process from snapshot data storage volumes in case of data corruption of primary data storage volumes. For example, the snapshot storage management techniques provide snapshot volumes to provide snapshots that reference primary storage volumes to be used during a data restore process.

The process of FIGS. 3A and 3C shows example processes and it should be understood that other configurations can be employed to practice the techniques of the present application. For example, the process may be configured to process primary space 108 and snapshot space 110 that reside on different storage devices 106.

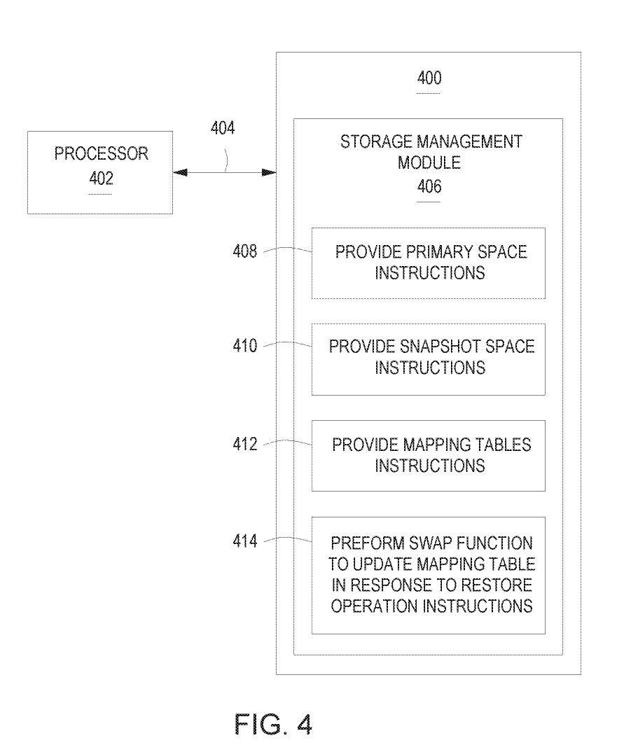

FIG. 4 is an example block diagram showing a non-transitory, computer-readable medium that stores code for operation in accordance with an example of the techniques of the present application. The non-transitory, computer-readable medium is generally referred to by the reference number 400 and may be included in the system in relation to FIG. 1. The non-transitory, computer-readable medium 400 may correspond to any typical storage device that stores computer-implemented instructions, such as programming code or the like. For example, the non-transitory, computer-readable medium 400 may include one or more of a non-volatile memory, a volatile memory, and/or one or more storage devices. Examples of non-volatile memory include, but are not limited to, electrically erasable programmable Read Only Memory (EEPROM) and Read Only Memory (ROM). Examples of volatile memory include, but are not limited to, Static Random Access Memory (SRAM), and dynamic Random Access Memory (DRAM). Examples of storage devices include, but are not limited to, hard disk drives, compact disc drives, digital versatile disc drives, optical drives, and flash memory devices.

A processor 402 generally retrieves and executes the instructions stored in the non-transitory, computer-readable medium 400 to operate the present techniques in accordance with an example. In one example, the tangible, computer-readable medium 400 can be accessed by the processor 402 over a bus 404. A first region 406 of the non-transitory, computer-readable medium 400 may include storage management module 104 functionality as described herein. The module 104 functionality may be implemented in hardware, software or a combination thereof.

For example, block 408 provides instructions which may include instructions to provide primary space 108, as described herein. In one example, the instructions may include instructions to provide a primary space that includes a primary data storage volume to store primary data blocks, as described herein.

For example, block 410 provides instructions which may include instructions to provide snapshot space 110, as described herein. In one example, the instructions may include instructions to provide a snapshot data storage volume to store snapshot data that includes snapshot data blocks which represent COW data blocks of the primary data blocks, as described herein. In one example, the instructions may include instructions to provide the snapshot data storage volume to include snapshot pointers to reference the primary data blocks which represent non-COW data blocks of the primary data blocks of the primary data storage volume.

For example, block 412 provides instructions which may include instructions to provide mapping tables 112 described herein. In one example, the instructions may include instructions to provide mapping table to include primary volume mapping pointers to reference the primary data blocks, and provide snapshot volume mapping pointers to reference the snapshot data blocks, as described herein.

For example, block 414 provides instructions which may include instructions to perform swap function 114 to update mapping table in response to restore operation, as described herein. In one example, the instructions may include instructions to update mapping table to have the primary volume mapping pointers to reference corresponding COW data blocks of the snapshot data storage volume, as described herein. In one example, the instructions may include instructions to update mapping table to have the snapshot volume mapping pointers to reference corresponding primary data blocks of the primary data storage volume.

Although shown as contiguous blocks, the software components can be stored in any order or configuration. For example, if the non-transitory, computer-readable medium 400 is a hard drive, the software components can be stored in non-contiguous, or even overlapping, sectors.

As used herein, a “processor” may include processor resources such as at least one of a Central Processing Unit (CPU), a semiconductor-based microprocessor, a Graphics Processing Unit (GPU), a Field-Programmable Gate Array (FPGA) configured to retrieve and execute instructions, other electronic circuitry suitable for the retrieval and execution instructions stored on a computer-readable medium, or a combination thereof. The processor fetches, decodes, and executes instructions stored on medium 400 to perform the functionalities described below. In other examples, the functionalities of any of the instructions of medium 400 may be implemented in the form of electronic circuitry, in the form of executable instructions encoded on a computer-readable storage medium, or a combination thereof.

As used herein, a “computer-readable medium” may be any electronic, magnetic, optical, or other physical storage apparatus to contain or store information such as executable instructions, data, and the like. For example, any computer-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any computer-readable medium described herein may be non-transitory. In examples described herein, a computer-readable medium or media is part of an article (or article of manufacture). An article or article of manufacture may refer to any manufactured single component or multiple components. The medium may be located either in the system executing the computer-readable instructions, or remote from but accessible to the system (e.g., via a computer network) for execution. In the example of FIG. 4, medium 400 may be implemented by one computer-readable medium, or multiple computer-readable media.

In examples described herein, computing device 102 may communicate with components implemented on separate devices or system(s) via a network interface device of the computing device. For example, computing device 102 may communicate with storage device 106 via a network interface device of the computing device 102. In another example, computing device 102 may communicate with other computing devices via a network interface device of the computing device 102. In examples described herein, a “network interface device” may be a hardware device to communicate over at least one computer network. In some examples, a network interface may be a Network Interface Card (NIC) or the like. As used herein, a computer network may include, for example, a Local Area Network (LAN), a Wireless Local Area Network (WLAN), a Virtual Private Network (VPN), the Internet, or the like, or a combination thereof. In some examples, a computer network may include a telephone network (e.g., a cellular telephone network).

In some examples, instructions 408-414 may be part of an installation package that, when installed, may be executed by processor 402 to implement the functionalities described herein in relation to instructions 408-414. In such examples, medium 400 may be a portable medium, such as a CD, DVD, or flash drive, or a memory maintained by a server from which the installation package can be downloaded and installed. In other examples, instructions 408-414 may be part of an application, applications, or component(s) already installed on computing device 102 including processor 402. In such examples, the medium 400 may include memory such as a hard drive, solid state drive, or the like. In some examples, functionalities described herein in relation to FIGS. 1 through 4 may be provided in combination with functionalities described herein in relation to any of FIGS. 1 through 4.

The foregoing describes a novel and previously unforeseen approach for storage management. While the above application has been shown and described with reference to the foregoing examples, it should be understood that other forms, details, and implementations may be made without departing from the spirit and scope of this application.

What is claimed is:

1. A computing device for snapshot storage management, the computing device comprising:
a storage device to: provide a primary space that includes a primary data storage volume to store primary data blocks, and
a snapshot space to: provide a snapshot data storage volume to store snapshot data that includes snapshot data blocks which represent copy-on-write (COW) data blocks of the primary data blocks, and that includes snapshot pointers to reference the primary data blocks which represent non-COW data blocks of the primary data blocks of the primary data storage volume;
a mapping table to: provide primary volume mapping pointers to reference the primary data blocks, and provide snapshot volume mapping pointers to reference the snapshot data blocks; and
a storage management module, in response to a restore operation, to perform a swap function that includes to:
update the mapping table to have the primary volume mapping pointers to reference corresponding COW data blocks of the snapshot data storage volume,
update the mapping table to have the snapshot volume mapping pointers to reference corresponding primary data blocks of the primary data storage volume.

2. The computing device of claim 1, wherein the storage management module to, in response to a write operation and before a snapshot operation, write data blocks to the primary data storage volume and do not write the primary data blocks to the snapshot data storage volume.

3. The computing device of 1, wherein the storage management module to, in response to a write operation and after a snapshot operation, copy the primary data blocks from the primary data storage volume to the snapshot data volume and then overwrite the primary data blocks of the primary data storage volume.

4. The computing device of claim 1, wherein the storage management module to, in response to snapshot operation, have the snapshot pointers reference the primary data blocks which represent non-COW data blocks of the primary data blocks of the primary data storage volume.

5. The computing device of claim 1, wherein the COW data blocks represent primary data blocks from the primary data storage volume at the time of a snapshot operation before the primary data blocks were subsequently overwritten at the primary data storage volume, and wherein non-COW data blocks represent primary data blocks from the primary data storage volume at the time of a snapshot operation that have not been overwritten at the primary data storage volume.

6. A method of snapshot storage management, the method comprising:
providing a primary space that includes a primary data storage volume to store primary data blocks, and
providing a snapshot space that includes snapshot data storage volume to store snapshot data that includes snapshot data blocks which represent copy-on-write (COW) data blocks of the primary data blocks, and that includes snapshot pointers to reference the primary data blocks which represent non-COW data blocks of the primary data blocks of the primary data storage volume;
providing a mapping table that includes primary volume mapping pointers to reference the primary data blocks, and provide snapshot volume mapping pointers to reference the snapshot data blocks; and
in response to a restore operation, perform a swap function that includes:
updating the mapping table to have the primary volume mapping pointers to reference corresponding COW data blocks of the snapshot data storage volume,
updating the mapping table to have the snapshot volume mapping pointers to reference corresponding primary data blocks of the primary data storage volume.

7. The method of claim 6, further comprising, in response to a write operation and before a snapshot operation, writing data blocks to the primary data storage volume and not writing the primary data blocks to the snapshot data storage volume.

8. The method of claim 6, further comprising, in response to a write operation and after a snapshot operation, copying the primary data blocks from the primary data storage volume to the snapshot data volume and then overwriting the primary data blocks of the primary data storage volume.

9. The method of claim 6, further comprising, in response to snapshot operation, have the snapshot pointers reference the primary data blocks which represent non-COW data blocks of the primary data blocks of the primary data storage volume.

10. The method of claim 6, wherein the COW data blocks represent primary data blocks from the primary data storage volume at the time of a snapshot operation before the primary data blocks were subsequently overwritten at the primary data storage volume, and wherein non-COW data blocks represent primary data blocks from the primary data storage volume at the time of a snapshot operation that have not been overwritten at the primary data storage volume.

11. A non-transitory computer-readable medium having computer executable instructions stored thereon for snapshot storage management, the instructions are executable by a processor to:
provide a primary space that includes a primary data storage volume to store primary data blocks, and
provide a snapshot space that includes snapshot data storage volume to store snapshot data that includes snapshot data blocks which represent copy-on-write (COW) data blocks of the primary data blocks, and that includes snapshot pointers to reference the primary data blocks which represent non-COW data blocks of the primary data blocks of the primary data storage volume;
provide a mapping table that includes primary volume mapping pointers to reference the primary data blocks, and provide snapshot volume mapping pointers to reference the snapshot data blocks; and
in response to a restore operation, perform a swap function that includes to:
update the mapping table to have the primary volume mapping pointers to reference corresponding COW data blocks of the snapshot data storage volume,
update the mapping table to have the snapshot volume mapping pointers to reference corresponding primary data blocks of the primary data storage volume

12. The non-transitory computer-readable medium of claim 11, further comprising instructions that if executed cause a processor to: cause the COW data blocks to represent primary data blocks from the primary data storage volume at the time of a snapshot operation before the primary data blocks were subsequently overwritten at the primary data storage volume, and to cause the non-COW data blocks to represent primary data blocks from the primary data storage volume at the time of a snapshot operation that have not been overwritten at the primary data storage volume.

13. The non-transitory computer-readable medium of claim 11, further comprising instructions that if executed cause a processor to: in response to a write operation and after a snapshot operation, copy the primary data blocks from the primary data storage volume to the snapshot data volume and then overwrite the primary data blocks of the primary data storage volume.

14. The non-transitory computer-readable medium of claim 11 further comprising instructions that if executed cause a processor to: in response to snapshot operation, have the snapshot pointers reference the primary data blocks which represent non-COW data blocks of the primary data blocks of the primary data storage volume.

15. The non-transitory computer-readable medium of claim 11 further comprising instructions that if executed cause a processor to: process data blocks wherein the COW data blocks represent primary data blocks from the primary data storage volume at the time of a snapshot operation before the primary data blocks were subsequently overwritten at the primary data storage volume, and wherein non-COW data blocks represent primary data blocks from the primary data storage volume at the time of a snapshot operation that have not been overwritten at the primary data storage volume.
